(19) United States
(12) Patent Application Publication
(10) Pub. No.: US 2026/0039170 A1
(43) Pub. Date: Feb. 5, 2026

(54) FAN MOTOR

(71) Applicant: NEW MOTECH CO., LTD., Gwangju (KR)

(72) Inventors: Jeong Cheol JANG, Gwangju (KR); Kyoung Joo LEE, Gwangju (KR); Min Seong KIM, Gwangju (KR); Jeong Hyun SONG, Gwangju (KR)

(73) Assignee: NEW MOTECH CO., LTD., Gwangju (KR)

(21) Appl. No.: 18/995,209

(22) PCT Filed: Aug. 16, 2023
(86) PCT No.: PCT/KR2023/012098

§ 371 Date: Jan. 16, 2025

(30) Foreign Application Priority Data
Sep. 30, 2022 (KR) 10-2022-0125025

(51) Int. Cl. H02K 7/14; H02K 5/24; H02K 7/00; H02K 7/08

(52) U.S. Cl. CPC H02K 7/14; H02K 5/24; H02K 7/003; H02K 7/085

(57) ABSTRACT

A fan motor (100) is disclosed according to the present disclosure, which comprises a rotor (10) formed by insert injection molding in a shaft (30), rotating together with the shaft (30); a stator (20) installed to be oriented towards the rotor (10); an upper insulator (21) constituting the stator (20) and upper and lower insulators (21, 23) coupled to the upper and lower parts of a core (22) of the stator (20); a motor bracket (60) coupling the upper and lower insulators (21, 23) and a printed circuit board (50); and a rotor separation preventing and shock absorbing means (80) fitted to an annular groove (31) having a recessed shape in the lower end of the shaft (30) inserted into a sleeve bearing (40) installed inside a fitting protrusion (61) protruding from the center of the motor bracket (60).

### TECHNICAL FIELD

The present invention relates to a fan motor. More specifically, the present invention relates to a fan motor for a refrigerator capable of reducing the manufacturing cost through the shortening of a motor assembling process by preventing the separation of a rotor ascending upon rotation of a fan without a top-covering bracket, and improving the performance of the fan motor by absorbing vibration occurring when the rotor ascends and increasing noise reduction efficiency.

### BACKGROUND ART

In general, a fan motor is used for blowing cool air in a refrigerator or circulating air inside and outside an apparatus. The fan motor is configured to bring a lead wire connected with an external power terminal block into contact with a printed circuit board installed in the fan motor, to rotate a fan by a rotating shaft rotating together with a rotor of the fan motor according to a control signal of a control circuit.

Korean Patent No. 10-1869951 discloses a fan motor. The fan motor comprises a rotor, a stator, a shaft, an oilless bearing, a printed circuit board, a top-covering bracket made of a synthetic resin, a fixing installation bracket made of a synthetic resin, attached to an apparatus such as a refrigerator, a motor bracket made of a synthetic resin, and a fan fitted to the shaft to rotate.

The fan motor comprises a rotor formed by insert injection molding in a shaft, rotating together with the shaft; a stator installed to be oriented towards the rotor; a top-covering bracket coupling an upper insulator constituting the stator and a motor bracket; and a motor bracket seated on a fixing installation bracket, coupling a core of the stator, upper and lower insulators and a printed circuit board. The motor bracket comprises a fitting protrusion having a space thereinside protruding from the center; a plurality of fixing guide pieces protruding inwardly from the inner circumferential surface at regular intervals; a lead wire outlet hole at one side of the motor bracket, electrically connected to the printed circuit board; and a fixing piece protruding outwardly for a fixing bolt. The motor bracket is installed by seating the fixing piece on a locking projection formed inside the fixing installation bracket, and then fixing the same with a fixing bolt.

The prior art having the above configuration couples the top-covering bracket to the upper part of the motor bracket with a coupling means in order to avoid the concern that the rotor including the shaft might separate from the motor bracket while ascending by the blade rotational power of the fan upon fan rotation.

However, the top-covering bracket provided to prevent the separation of the rotor causes the assembling process to prolong, thereby decreasing productivity, and requires the additional cost incurred therefor, thereby increasing the cost for manufacturing the motor.

In addition, when the rotor ascends by the blade rotational power of the fan while rotating, the upper circumferential surface of the rotor collides with the inner circumferential surface of the top-covering bracket. This might damage the top-covering bracket, thereby decreasing the durability of the motor, and also noise occurs, thereby degrading the performance of the motor.

Accordingly, in order to overcome the above problem, the present inventors suggest a fan motor having a novel structure capable of preventing the separation of a rotor without coupling a top-covering bracket.

### DISCLOSURE OF INVENTION

### Technical Problem

It is an object of the present invention to provide a fan motor by installing, in the lower end of a shaft, a rotor separation preventing and shock absorbing means capable of preventing the separation of a rotor and also absorbing vibration when the rotor ascends by the blade rotational power of a fan while rotating.

The above and other inherent objects of the present invention may all be easily achieved by the description of the present invention described below.

### Solution to Problem

The fan motor 100 according to the present invention comprises a rotor 10 formed by insert injection molding in a shaft 30, rotating together with the shaft 30; a stator 20 installed to be oriented towards the rotor 10; an upper insulator 21 constituting the stator 20 and upper and lower insulators 21, 23 coupled to the upper and lower parts of a core 22 of the stator 20; a motor bracket 60 coupling the upper and lower insulators 21, 23 and a printed circuit board 50; and a rotor separation preventing and shock absorbing means 80 fitted to an annular groove 31 having a recessed shape in the lower end of the shaft 30 inserted into a sleeve bearing 40 installed inside a fitting protrusion 61 protruding from the center of the motor bracket 60.

In the present invention, the rotor separation preventing and shock absorbing means 80 may comprise a body 81 of a washer shape having a fitting hole 81′ formed in the center; and upper and lower vibration isolating members 82, 83 coupled to the top and bottom surfaces of the body 81.

In the present invention, a fitting protrusion 82A of the upper vibration isolating member 82 and a fitting protrusion 83A of the lower vibration isolating member 83 may be fitted and coupled to a fitting hole 81″ formed through between the outer circumference of a fitting hole 81′ of the body 81 and the outer edge of the body 81.

In the present invention, preferably, a noise absorbing member 80A is installed between the fitting protrusion 82A of the upper vibration isolating member 82 and the fitting protrusion 83A of the lower vibration isolating member 83.

In the present invention, preferably, the body 81 is formed integrally with the upper and lower vibration isolating members 82, 83 by insert injection molding.

### Advantageous Effects of Invention

The present invention prevents the separation of a rotor ascending when the fan of a fan motor rotates without coupling a top-covering bracket for preventing the separation of the rotor, thereby shortening the assembling process of a motor, resulting in improvement of productivity and reduction of the cost for manufacturing a motor.

Also, the present invention increases the durability of a motor without the concern of collision with a top-covering bracket upon rotation of a rotor.

Also, the present invention uses upper and lower vibration isolating members of a rotor separation preventing and shock absorbing means to absorb vibration when the rotor ascends, thereby preventing damage of the lower circumferential surface of a sleeve bearing, resulting in improvement of the durability of a fan motor and also significant increase in reliability of a motor.

Also, the present invention provides a fan motor with improved noise reduction efficiency by using the rotor separation preventing and shock absorbing means to absorb vibration occurring when a shaft ascends.

### BRIEF DESCRIPTION OF DRAWINGS

FIG. 1 is a perspective view of the coupling of a fan motor according to the present invention;

FIG. 2 is a cross-sectional view of a fan motor according to the present invention;

FIG. 3 is an exploded perspective view of a fan motor according to the present invention;

FIG. 4 is a perspective view of the coupling of a motor bracket of a fan motor according to the present invention;

FIG. 5 is an enlarged cross-sectional view of the coupling of a motor bracket of a fan motor according to the present invention;

FIG. 6 is an enlarged cross-sectional view of the state in which a rotor separation preventing and shock absorbing means of a fan motor according to the present invention is installed;

FIG. 7 is an exploded cross-sectional view of the configuration of a rotor separation preventing and shock absorbing means of a fan motor according to the present invention; and

FIG. 8 is a combined cross-sectional view of the configuration of a rotor separation preventing and shock absorbing means of a fan motor according to the present invention.

Hereinafter, the present invention will be described in detail with reference to the accompanying drawings.

### MODE FOR THE INVENTION

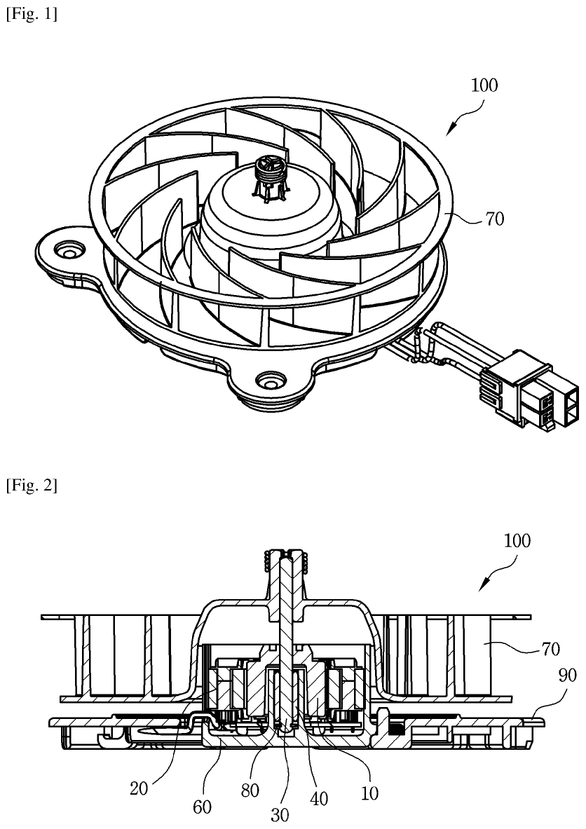

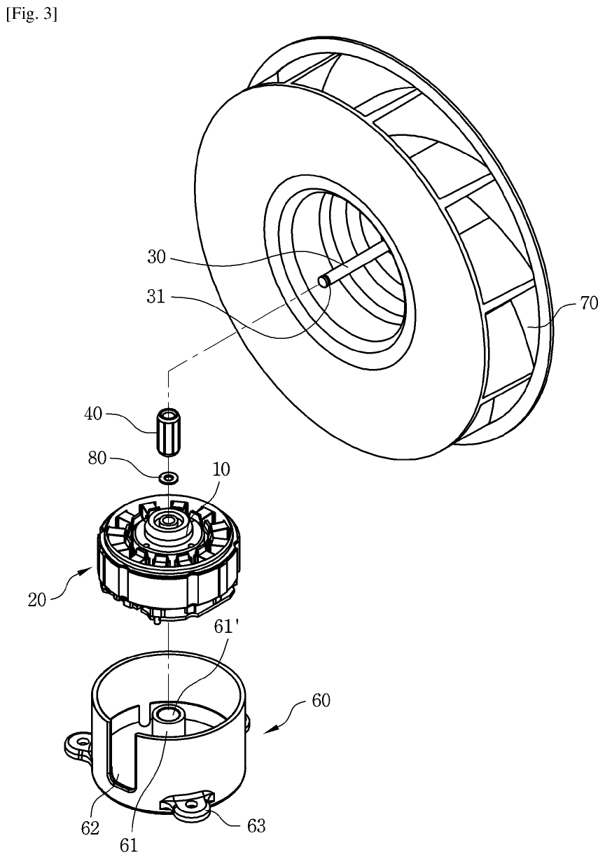

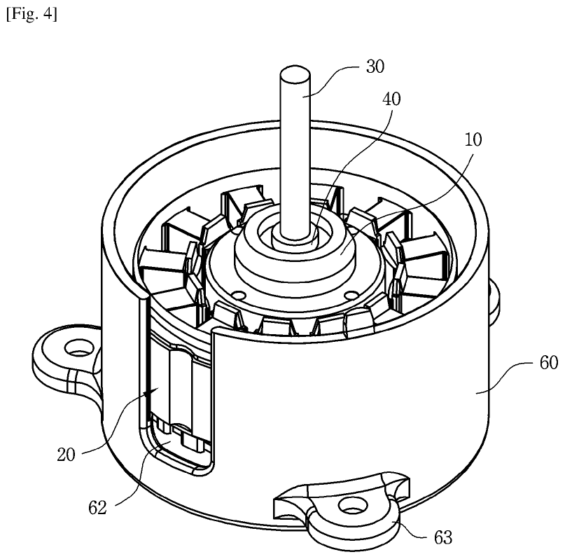

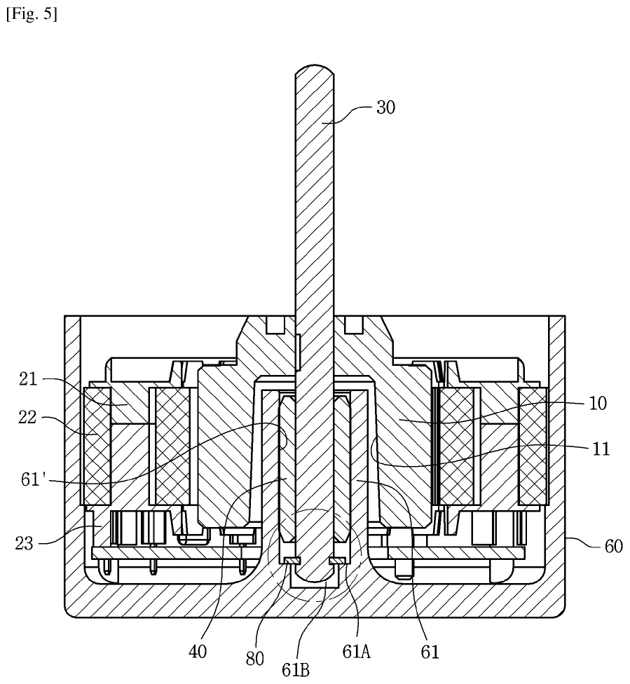

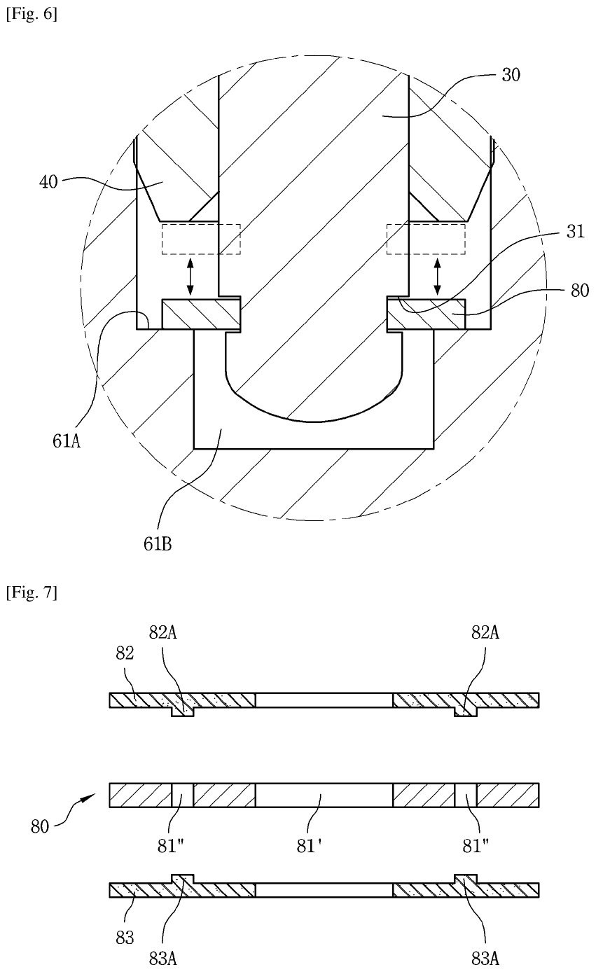

FIG. 1 is a perspective view of the coupling of a fan motor according to the present invention, FIG. 2 is a cross-sectional view of a fan motor according to the present invention, FIG. 3 is an exploded perspective view of a fan motor according to the present invention, FIG. 4 is a perspective view of the coupling of a motor bracket of a fan motor according to the present invention, FIG. 5 is an enlarged cross-sectional view of the coupling of a motor bracket of a fan motor according to the present invention, and FIG. 6 is an enlarged cross-sectional view of the state in which a rotor separation preventing and shock absorbing means of a fan motor according to the present invention is installed.

As illustrated in FIGS. 1 to 6, a fan motor 100 according to the invention comprises a rotor 10, a stator 20, a shaft 30, a sleeve bearing 40, a printed circuit board 50, a motor bracket 60, and a fan 70 fitted to the shaft 30 to rotate.

The rotor 10 is manufactured by injection molding by placing the shaft 30 in an insert injection mold to rotate together with the shaft 30. The stator 20 is installed to be oriented towards the rotor 10, and the rotor 10 rotates by a changing magnetic field generated by the stator 20. An upper insulator 21 and a lower insulator 23 are coupled to the upper part and the lower part of the stator 20, respectively.

A core 22 and upper and lower insulators 21, 23 of the stator 20 and the printed circuit board 50 are coupled inside the motor bracket 60.

The motor bracket 60 comprises a fitting protrusion 61 having a first space 61′ thereinside protruding from the center; a lead wire outlet hole 62; and a fixing piece 63.

The rotor 10 is arranged such that the inner circumference of a second space 11 formed inside the center of the rotor 10 is disposed around the outer circumference of the fitting protrusion 61 of the motor bracket 60 with a predetermined interval, and a third space 61B having an annular locking step 61A is formed in the lower part of the fitting protrusion 61 of the motor bracket 60. Reference numeral 90 in the drawings is a fixing installation bracket.

The present invention may fit a rotor separation preventing and shock absorbing means 80 to an annular groove 31 having a recessed shape in the lower end of the shaft 30 inserted into the sleeve bearing 40 installed inside the fitting protrusion 61 protruding from the center of the motor bracket 60, thereby preventing the separation of the rotor 10 when the shaft 30 ascends due to the rotational power generated upon rotation of the fan 70.

Accordingly, the present invention may omit a top-covering bracket which is necessarily included in the conventional fan motors for preventing the separation of the rotor 10 and also omit a separate coupling means for coupling the top-covering bracket and the motor bracket 60. Thus, the present invention is capable of providing a fan motor 100 with a simple structure, and also shortening the assembling process and reducing the cost for manufacturing a fan motor.

Referring to FIGS. 5 and 6, when the rotor 10 including the shaft 30 ascends due to the rotational power generated upon rotation of the fan 70, the top surface of the rotor separation preventing and shock absorbing means 80 is in contact with the sleeve bearing 40 to serve as a stopper. As such, separation of the rotor 10 as well as the shaft 30 is prevented without installing a top-covering bracket, allowing the fan 70 to be stably driven. When the rotor 10 descends, the bottom surface of the rotor separation preventing and shock absorbing means 80 is in contact with the upper circumferential surface of the annular locking step 61A in the lower part of the fitting protrusion 61 to stop the shaft 30 from descending, thereby allowing the rotor 10 to stably rotate in the horizontal direction of the shaft 30.

When the rotor 10 ascends, the top and bottom surfaces of the rotor separation preventing and shock absorbing means 80 is in contact with the sleeve bearing 40 and the annular locking step 61A. Thereby, the lower circumferential surface of the sleeve bearing 40 and the annular locking step 61A may be damaged, or noise may be generated by vibration occurring upon contacting. Due to the damage of the sleeve bearing 40, the rotation of the shaft 30 may be disturbed. Also, due to the damage of the annular locking step 61A, the descending limit may be exceeded when the shaft 30 descends, and the lower part of the fan 70 is in contact with the circumference of the motor bracket 60, leading to a severe shock and causing damage to the fan 70.

In order to prevent the above situation, the present invention suggests that the rotor separation preventing and shock absorbing means 80 comprises a body 81 of a washer shape having a fitting hole 81′ formed in the center; and upper and lower vibration isolating members 82, 83 coupled to the top and bottom surfaces of the body 81.

The body 81 of a washer shape may be made of a steel sheet, and may be made of an elastic steel sheet.

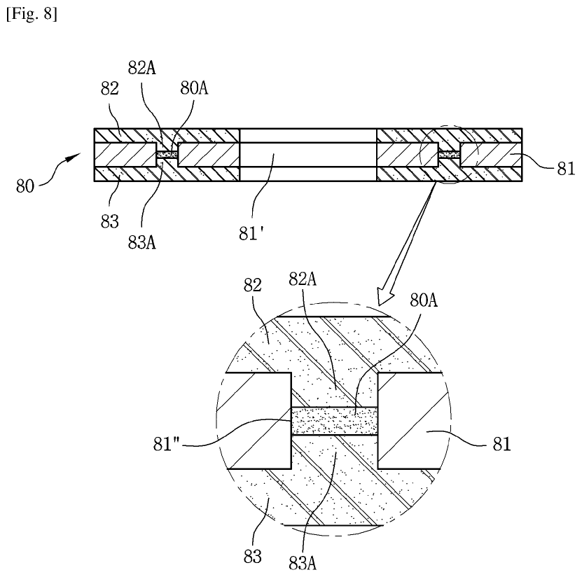

FIG. 7 is an exploded cross-sectional view of the configuration of a rotor separation preventing and shock absorbing means of a fan motor according to the present invention, and FIG. 8 is a combined cross-sectional view of the configuration of a rotor separation preventing and shock absorbing means of a fan motor according to the present invention.

Preferably, the upper and lower vibration isolating members 82, 83 are made of synthetic rubber such as fluoro rubber, nitrile rubber, or acrylic rubber, having excellent sliding and shock absorbing properties.

Particularly, a plurality of fitting protrusions 82A of the upper vibration isolating member 82 and a plurality of fitting protrusions 83A of the lower vibration isolating member 83 may be fitted and coupled to a plurality of fitting holes 81″ formed through between the outer circumference of the fitting hole 81′ of the body 81 and the outer edge of the body 81 at regular intervals, and may be adhered and coupled thereto with an adhesive (not shown).

The rotor separation preventing and shock absorbing means 80 having the above configuration may maintain firmness by reinforcing the body 81 with the upper and lower vibration isolating members 82, 83. Further, the rotor separation preventing and shock absorbing means 80 may enable smooth rotation and prevent noise occurring upon contacting, and reduce abrasion of the body 81 by the upper and lower vibration isolating members 82, 83 made of rubber having excellent sliding properties even when the top surface and the bottom surface of the upper and lower vibration isolating members 82, 83 are in contact with the lower circumferential surface of the sleeve bearing 40 and the upper circumferential surface of the annular locking step 61A to rotate, while rotating together with the shaft 30.

When the rotor 10 ascends, the upper vibration isolating member 82 of the rotor separation preventing and shock absorbing means 80 reduces a shock occurring when the upper circumferential surface of the upper vibration isolating member 82 is in contact with the lower circumferential surface of the sleeve bearing 40, thereby preventing the damage of the sleeve bearing 40, and also absorbing vibration and reducing noise.

When the rotor 10 descends, the lower vibration isolating member 83 of the rotor separation preventing and shock absorbing means 80 reduces a shock occurring when the lower circumferential surface of the lower vibration isolating member 83 is in contact with the upper circumferential surface of the annular locking step 61A, thereby preventing the damage of the annular locking step 61A, and preventing the exceeding of descending limit when the shaft 30 descends, avoiding a severe shock occurring when the lower part of the fan 70 is in contact with the circumference of the motor bracket 60.

A noise absorbing member 80A is interposed between the fitting protrusion 82A of the upper vibration isolating member 82 and the fitting protrusion 83A of the lower vibration isolating member 83, allowing the noise absorbing member 80A to absorb vibration occurring when the upper and lower vibration isolating members 82, 83 are in contact with the sleeve bearing 40 and the annular locking step 61A, thereby significantly improving noise reduction efficiency.

The present invention may form the body 81 integrally with the upper and lower vibration isolating members 82, 83 by insert injection molding, thereby capable of improving productivity of the rotor separation preventing and shock absorbing means 80.

It should be noted that the description of the present invention described above is merely an example for understanding the present invention, and is not intended to limit the scope of the present invention. The scope of protection of the present invention is defined by the accompanying claims, and it should be construed that simple modifications or alternations within the scope of the claims fall within the scope of the present invention.

1. A fan motor comprising:
a rotor 10 formed by insert injection molding in a shaft 30, rotating together with the shaft 30;
a stator 20 installed to be oriented towards the rotor 10;
an upper insulator 21 constituting the stator 20 and upper and lower insulators 21, 23 coupled to the upper and lower parts of a core 22 of the stator 20;
a motor bracket 60 coupling the upper and lower insulators 21, 23 and a printed circuit board 50; and
a rotor separation preventing and shock absorbing means 80 fitted to an annular groove 31 having a recessed shape in the lower end of the shaft 30 inserted into a sleeve bearing 40 installed inside a fitting protrusion 61 protruding from the center of the motor bracket 60.

2. The fan motor of claim 1, wherein the rotor separation preventing and shock absorbing means 80 comprises a body 81 of a washer shape having a fitting hole 81′ formed in the center; and upper and lower vibration isolating members 82, 83 coupled to the top and bottom surfaces of the body 81.

3. The fan motor of claim 2, wherein a fitting protrusion 82A of the upper vibration isolating member 82 and a fitting protrusion 83A of the lower vibration isolating member 83 are fitted and coupled to a fitting hole 81″ formed through between the outer circumference of a fitting hole 81′ of the body 81 and the outer edge of the body 81.

4. The fan motor of claim 2, wherein a noise absorbing member 80A is installed between the fitting protrusion 82A of the upper vibration isolating member 82 and the fitting protrusion 83A of the lower vibration isolating member 83.

5. The fan motor of claim 2, wherein the body 81 is formed integrally with the upper and lower vibration isolating members 82, 83 by insert injection molding.
